(19) United States
(12) Patent Application Publication
(10) Pub. No.: US 2023/0057920 A1
(43) Pub. Date: Feb. 23, 2023

(54) INFORMATION PROCESSING SYSTEM, PERIPHERAL DEVICE, AND SETTING METHOD

(71) Applicant: PFU LIMITED, Ishikawa (JP)

(72) Inventor: Masateru IKEOKA, Ishikawa (JP)

(21) Appl. No.: 17/864,842

(22) Filed: Jul. 14, 2022

(30) Foreign Application Priority Data
Aug. 19, 2021 (JP) 2021-133745

(51) Int. Cl. H04W 76/14; H04W 48/16

(52) U.S. Cl. CPC H04W 76/14; H04W 48/16; H04W 84/12

(57) ABSTRACT

An object is to provide an information processing system for facilitating setting of a peripheral device. An information processing system includes a computer terminal and a peripheral device. The computer terminal includes a connection information storage unit configured to store first wireless connection information for connecting by wireless to a predetermined access point, and a connection request unit configured to request a wireless connection by using the first wireless connection information stored by the connection information storage unit. The peripheral device includes a wireless connection unit configured to establish a wireless connection by using second wireless connection information different from the first wireless connection information, and a connection information replacement unit configured to replace the second wireless connection information used by the wireless connection unit with the first wireless connection information.

### CROSS-REFERENCE TO RELATED APPLICATIONS

This application is based on and claims priority under 35 USC 119 from Japanese Patent Application No. 2021-133745 filed Aug. 19, 2021.

### BACKGROUND

### Technical Field

The present disclosure relates to an information processing system, a peripheral device, and a setting method.

### Related Art

For example, Japanese Unexamined Patent Application Publication No. 2019-177542 discloses an image processing apparatus including a first communication interface configured to perform communication by a first communication method, a second communication interface configured to perform communication by a second communication method different from the first communication method, an image processing unit, and a control unit. The image processing apparatus complies with a specific setting protocol including a procedure for receiving setting information of the first communication method from an operating system of an information processing device. The control unit is characterized in executing a first transmission process of transmitting, to the information processing device via the second communication interface, information indicating that the image processing apparatus complies with the specific setting protocol, a first reception process of receiving, via the second communication interface by following the specific setting protocol, after sharing with the information processing device by the first transmission process information that both the image processing apparatus and the information processing device comply with the specific setting protocol, the setting information of the first communication method transmitted from the operating system of the information processing device, and a setting process of performing setting of the first communication method by using the received setting information, when the setting information of the first communication method is received in the first reception process.

Furthermore, Japanese Unexamined Patent Application Publication No. 2014-195150 discloses a communication control program executable by a control unit of a communication apparatus. The communication apparatus includes a first communication unit configured to communicate with an external device by a near-field communication method, a second communication unit configured to communicate with an external device by a wireless communication method different from the near-field communication method, a storage unit including a first storage region assigned to the communication control program, and the control unit.

The communication control program is characterized in causing the control unit to function as a first determination means for determining whether a wireless setting for performing wireless communication via the second communication unit is stored in the first storage region, a request means for requesting, from an external device via the first communication unit, when communication with the external device is possible via the first communication unit, a wireless setting for communicating by wireless with the external device via the second communication unit, and a communication control means for setting, when the first determination means determines that the wireless setting is not stored in the first storage region, and when, in response to the request from the request means, the wireless setting for communicating by wireless with the external device via the second communication unit is acquired from the external device via the first communication unit, the acquired wireless setting as the wireless setting for performing wireless communication via the second communication unit.

Moreover, Japanese Unexamined Patent Application Publication No. 2021-057804 discloses a computer program for a terminal device. The terminal device includes a display unit, a wireless interface, a memory for storing an operating system (abbreviated as OS) program, and a computer. The computer program causes the computer to function as the following units, that is, as a first display control unit and a transmission unit. The first display control unit causes the display unit to display a guidance screen indicating that a predetermined operation needs to be executed on the terminal device. The predetermined operation is an operation of selecting, on a wireless setting screen displayed on the display unit by the OS program, a first identifier that identifies a communication device operating as a master station of a wireless network. When the predetermined operation is executed on the terminal device and thus, a first wireless connection via the wireless interface is established between the terminal device and the communication device, the transmission unit transmits, to the communication device via the wireless interface, connection information for establishing a second wireless connection with an access point.

### SUMMARY

An object of the present disclosure is to provide an information processing system for facilitating setting of a peripheral device.

An information processing system according to the present disclosure is an information processing system including a computer terminal, and a peripheral device. The computer terminal includes a connection information storage unit configured to store first wireless connection information for connecting by wireless to a predetermined access point, and a connection request unit configured to request a wireless connection by using the first wireless connection information stored by the connection information storage unit, and the peripheral device includes a wireless connection unit configured to establish a wireless connection by using second wireless connection information different from the first wireless connection information, and a connection information replacement unit configured to replace the second wireless connection information used by the wireless connection unit with the first wireless connection information.

Preferably, the connection information storage unit stores the first wireless connection information in association with software for controlling the peripheral device.

Preferably, the computer terminal further includes a setting information transmission unit configured to transmit, to the peripheral device, setting information relating to a wireless connection, by using a wireless connection using the first wireless connection information, and the connection information replacement unit further includes a connection information change-back unit configured to change the first wireless connection information back to the second wireless connection information, when the setting information relating to the wireless connection is transmitted by the setting information transmission unit.

Preferably, the connection information storage unit stores, as the first wireless connection information, a common SSID and password that are common to a plurality of peripheral devices, the connection information replacement unit replaces a unique SSID and password that are unique to each of the plurality of peripheral devices with the common SSID and password, and the connection information change-back unit changes the common SSID and password back to the unique SSID and password.

Preferably, the connection information replacement unit performs replacement to the first wireless connection information used for receiving setting information for a wireless connection, when a predetermined activation operation is performed.

Furthermore, a peripheral device according to the present disclosure includes a wireless connection unit configured to receive a wireless connection by using predetermined wireless connection information, a connection information replacement unit configured to change wireless connection information of the wireless connection unit, to setting wireless connection information different from the predetermined wireless connection information, and a connection information change-back unit configured to change the wireless connection information back to the predetermined wireless connection information, when receiving setting information by using the setting wireless connection information.

Moreover, a setting method according to the present disclosure includes replacing predetermined wireless connection information with setting wireless connection information different from the predetermined wireless connection information, and changing the setting wireless connection information set as a result of the replacing, back to the predetermined wireless connection information, when receiving setting information by using the setting wireless connection information.

Advantageous effects of the present disclosure are possible to facilitate setting of a peripheral device.

### BRIEF DESCRIPTION OF THE DRAWINGS

FIG. 1 is a diagram illustrating an overall configuration of an information processing system 1.

FIGS. 2A and 2B are diagrams for describing an outline of a WiFi setting method in the information processing system 1.

FIG. 3 is a diagram illustrating a hardware configuration of a computer terminal 2.

FIG. 4 is a diagram illustrating mainly a hardware configuration of a control portion of a scanner 4.

FIG. 5 is a diagram illustrating a functional configuration of the computer terminal 2.

FIG. 6 is a diagram illustrating a functional configuration of the scanner 4.

FIG. 7 is a table showing connection information registered in a connection information database 570.

FIG. 8 is a sequence chart for describing an overall operation (S10) of the information processing system 1.

FIG. 9 is a flowchart for describing a processing (S20) by the computer terminal in the information processing system 1 in more detail.

FIG. 10 is a flowchart for describing a processing (S30) by the scanner in the information processing system 1 in more detail.

FIG. 11 is a diagram illustrating variations of a specific activation method for the scanner 4.

### DESCRIPTION OF THE EMBODIMENTS

An embodiment of the present disclosure will be described below with reference to the drawings.

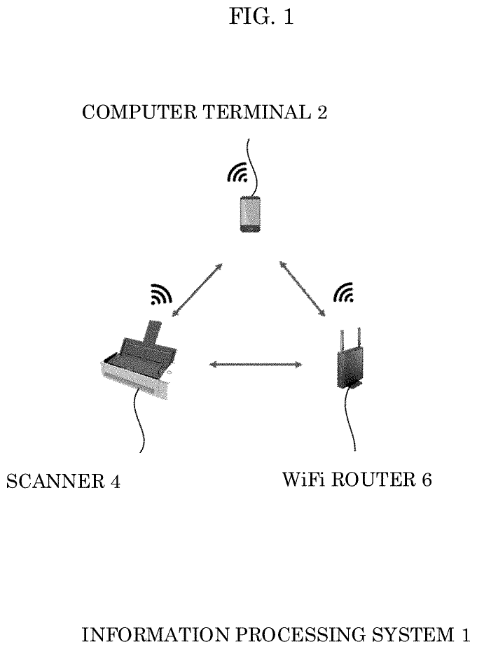

FIG. 1 is a diagram illustrating an overall configuration of an information processing system 1.

As illustrated in FIG. 1, the information processing system 1 includes a computer terminal 2, a scanner 4, and a WiFi router 6, and the computer terminal 2 is connected by wireless to the WiFi router 6.

The computer terminal 2 is a computer terminal operated by a user, and performs a setting operation for the scanner 4. For example, the computer terminal 2 is a mobile terminal such as a smartphone and a tablet terminal, or a personal computer.

The scanner 4 is an image reading device that optically reads an image from a document. The scanner 4 may function as an access point (master device) or a slave device in a wireless network such as wireless fidelity (WiFi), and may be directly connected to the computer terminal 2 by wireless (direct connection), or may be connected to the computer terminal 2 via the WiFi router 6. The scanner 4 is an example of a peripheral device according to the present disclosure.

The WiFi router 6 is an access point in the wireless network. The WiFi router 6 enables a wireless connection from the computer terminal 2, based on wireless connection information, for example. The wireless connection information is information for enabling a wireless connection, and is, for example, a set of a service set identifier (SSID) and a password.

In the above-described configuration, when a peripheral device such as a scanner or a camera is connected to and utilized by the computer terminal 2 (a mobile terminal or the like) via a wireless network, it is generally necessary to set a wireless connection.

There are generally two types of such connection methods. One connection method is “direct connection”. In the direction connection, a peripheral device such as the scanner 4 serves as an access point (AP), and the computer terminal 2 is connected when entering a network of the peripheral device. The other connection method is “AP connection”. In the AP connection, a peripheral device (the scanner 4) and the computer terminal 2 are connected via an access point such as the WiFi router 6.

Here, in order to utilize the AP connection, it is necessary to write wireless connection information (the SSID and the like) of the AP to the device, but communication means of the device are limited, and thus, in general, the computer terminal 2 and the peripheral device (the scanner 4 or the like) are in most cases connected temporarily by utilizing a direct connection, and a user sets an AP connection setting.

In such a case, connection by a person other than an owner of the peripheral device is usually restricted as follows. A unique SSID and password (in many cases, attached to the peripheral device by a sticker and the like) assigned individually during shipping from the factory are used as the wireless connection information for direct connection to prevent unauthorized setting by a third party.

However, in this method, the setting is complicated and difficult to understand. For example, in order to establish a direct connection, a user first needs to actively change a wireless setting of an operating system (OS), and after completing the setting of the AP connection, needs to change back to the wireless setting again. Therefore, even if the procedure is explained, many users feel that effort required to use is too great.

That is, the problem is that, in order to set the AP connection, it is necessary to set the direct connection.

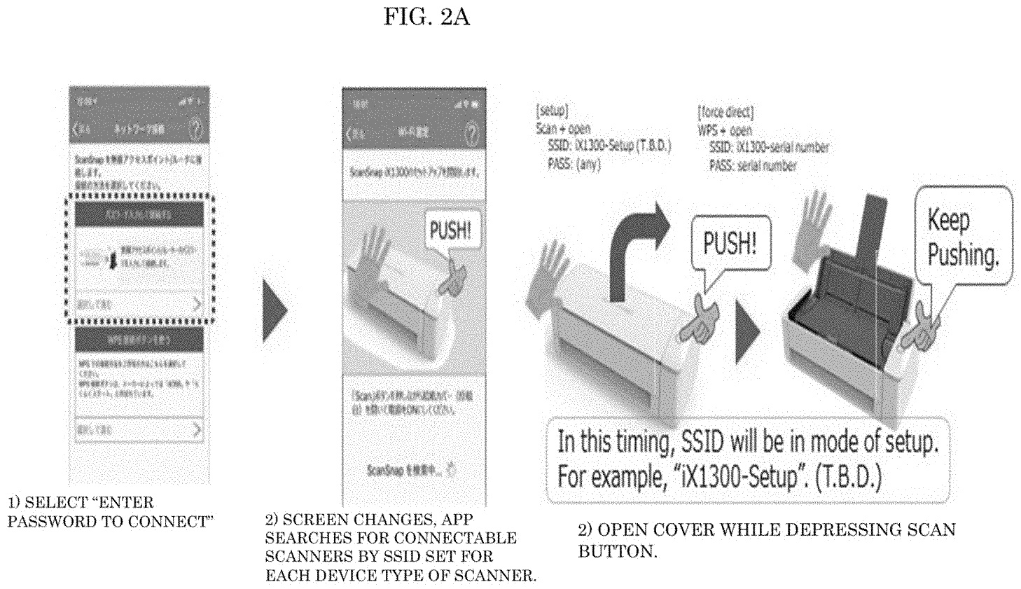

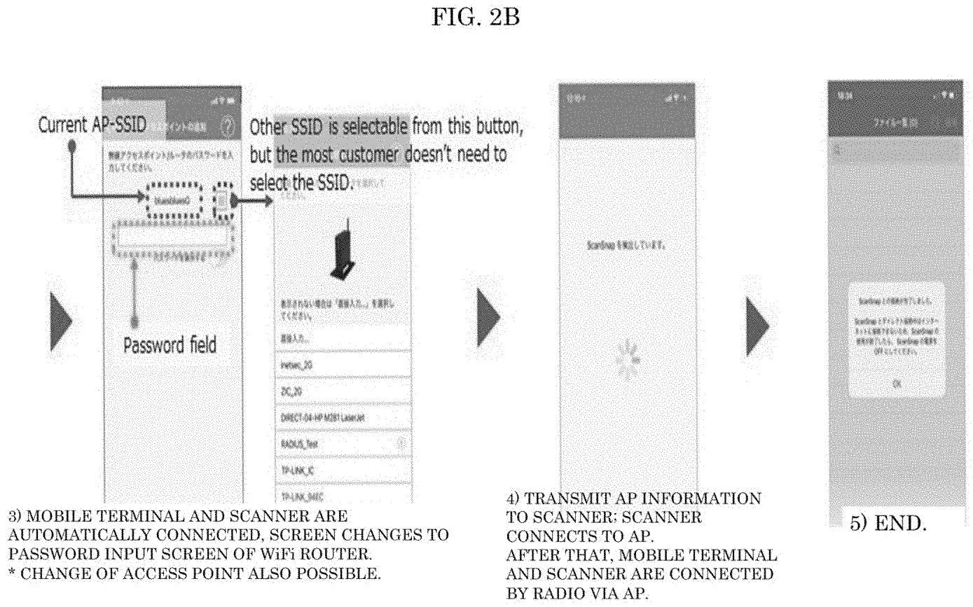

In the information processing system 1 of the present embodiment, in order to eliminate the setting work (to make the user not feel the existence of the setting work) for the direct connection in the process of setting the AP connection, the peripheral device is activated in a specific activation method and wireless connection information common to each device type is used, so that the peripheral device and the WiFi router 6 are automatically connected by wireless and a burden to the user is reduced. More specifically, as illustrated in FIGS. 2A and 2B, if the user opens a cover of the scanner 4 while depressing a scan button (an action corresponding to the “specific activation method”), the scanner 4 serves as an access point in which common wireless connection information (an SSID and a password) is adopted. The computer terminal 2 automatically connects to the scanner 4 via a direct connection using the common wireless connection information stored in advance, and transitions to a state for setting work of the AP connection.

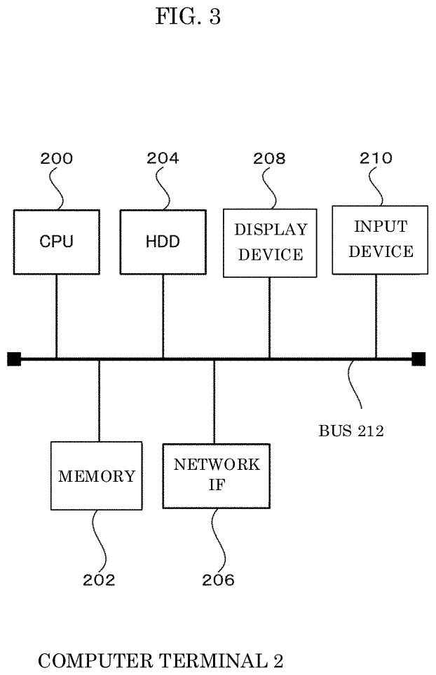

FIG. 3 is a diagram illustrating a hardware configuration of the computer terminal 2.

As illustrated in FIG. 3, the computer terminal 2 includes a CPU 200, a memory 202, an HDD 204, a network interface 206 (network IF 206), a display device 208, and an input device 210. These components are connected to each another via a bus 212.

The CPU 200 is a central processing unit, for example.

The memory 202 is a volatile memory, for example, and functions as a main storage device.

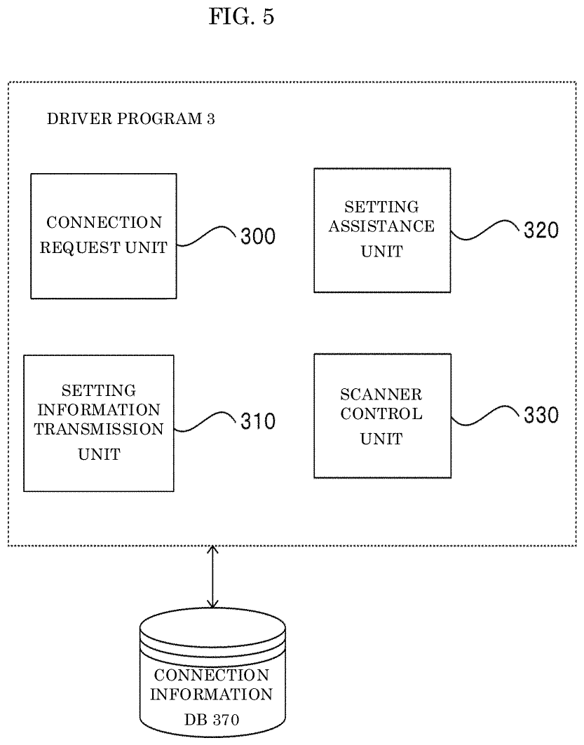

The HDD 204 is a hard disk drive device, for example, and serves as a non-volatile recording device to store a computer program (a driver program 3 of FIG. 5, for example) and another data file.

The network IF 206 is an interface for wired communication or wireless communication and realizes a connection to the scanner 4 and the WiFi router 6, for example.

The display device 208 is a liquid crystal display, for example. The input device 210 is a keyboard or a mouse, for example.

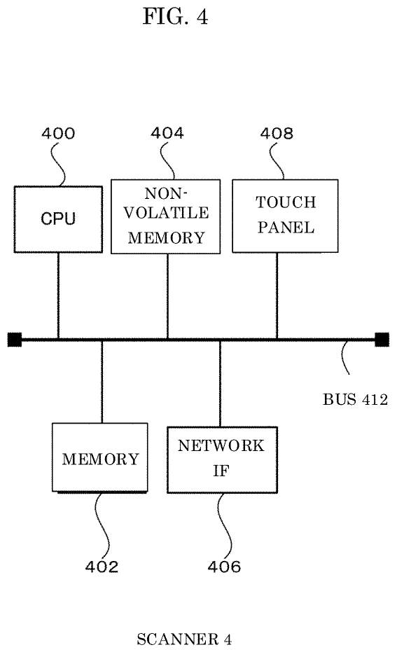

FIG. 4 is a diagram illustrating mainly a hardware configuration of a control portion of the scanner 4.

As illustrated in FIG. 4, the scanner 4 includes a CPU 400, a volatile memory 402, a non-volatile memory 404, a network interface 406 (network IF 406), and a touch panel 408. These components are connected to each another via a bus 412.

The CPU 400 is a central processing unit, for example.

The memory 402 is a volatile memory, for example, and functions as a main storage device.

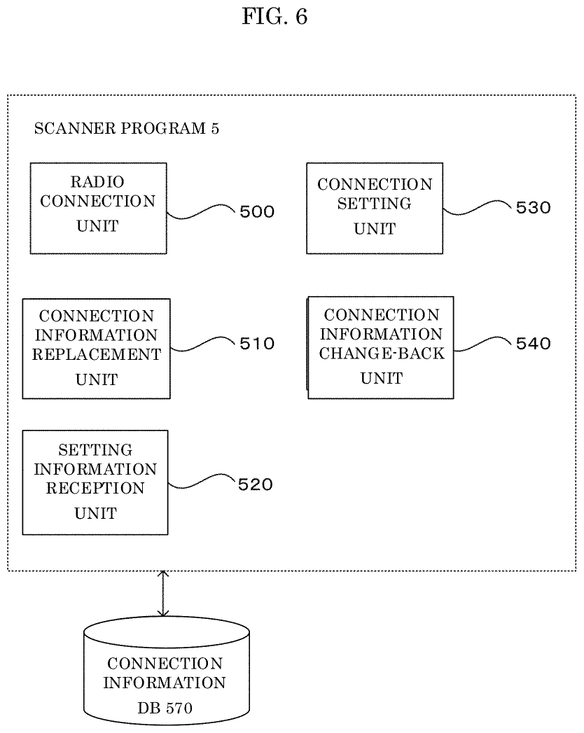

For example, the non-volatile memory 404 serves as a non-volatile recording device to store a computer program (a scanner program 5 of FIG. 6, for example) and another data file.

The network IF 406 is an interface for wired communication or wireless communication.

The touch panel 408 is a liquid crystal touch panel, for example.

FIG. 5 is a diagram illustrating a functional configuration of the computer terminal 2.

As illustrated in FIG. 5, the driver program 3 is installed in and operates in the computer terminal 2 of the present example, and a connection information database 370 (connection information DB 370) is configured in the computer terminal 2 of the present example. The driver program 3 is stored in a recording medium such as a CD-ROM, and is installed in the computer terminal 2 via the recording medium.

The driver program 3 is a driver program for controlling the scanner 4, and includes a connection request unit 300, a setting information transmission unit 310, a setting assistance unit 320, and a scanner control unit 330.

The driver program 3 may be partially or completely implemented by hardware such as an ASIC, or may be implemented by partially utilizing a function of an operating system (OS).

In the driver program 3, the connection request unit 300 uses wireless connection information (setting wireless connection information) stored in the connection information DB 370 to request the scanner 4 to establish a wireless connection. The connection information DB 370 is configured when the driver program 3 is installed, and the setting wireless connection information (the common SSID and password) is stored in the computer terminal 2 in association with the driver program 3. When performing wireless setting of the scanner 4, the connection request unit 300 of the present example uses the common SSID and password registered in the connection information DB 370 to automatically access the scanner 4.

The setting information transmission unit 310 transmits setting information relating to the wireless connection to the scanner 4, by using a wireless connection using the setting wireless connection information (first wireless connection information). That is, the setting information transmission unit 310 uses the wireless connection established by the connection request unit 300 to transmit, to the scanner 4, setting information for connecting the scanner 4 to the WiFi router 6 (specifically, an SSID and a password of the WiFi router 6).

The setting assistance unit 320 causes the computer terminal 2 to display information for supporting the setting work for connecting the scanner 4 to the WiFi router 6. As illustrated in FIGS. 2A and 2B, the setting assistance unit 320 of the present example causes the computer terminal 2 to display a guidance image indicating the “specific activation method” to the user, an input screen for inputting a password of the WiFi router 6, and the like.

The scanner control unit 330 serves as a driver program of the scanner 4 to control the scanner 4 in response to a user operation. For example, in response to the user operation, the scanner control unit 330 specifies an operation method of the scanner 4 (such as color/black and white, one-sided/double-sided, a resolution, and an output destination of scan data).

The connection information DB 370 stores an SSID and a password common to each device type of the scanner 4. The SSID and the password registered in advance in the connection information DB 370 may be common to each type of the driver program 3.

FIG. 6 is a diagram illustrating a functional configuration of the scanner 4.

As illustrated in FIG. 6, the scanner program 5 is installed in and operates in the scanner 4 of the present example, and a connection information database 570 (connection information DB 570) is configured in the scanner 4 of the present example. The scanner program 5 of the present example is installed in the scanner 4 in advance, but the configuration is not limited thereto. The scanner program 5 may be stored in a recording medium such as a CD-ROM, and installed in the scanner 4 via the recording medium.

The scanner program 5 includes a wireless connection unit 500, a connection information replacement unit 510, a setting information reception unit 520, a connection setting unit 530, and a connection information change-back unit 540.

The scanner program 5 may be partially or completely implemented by hardware such as an ASIC, or may be implemented by partially utilizing a function of an operating system (OS).

In the scanner program 5, the wireless connection unit 500 establishes a wireless connection by using unique wireless connection information (second wireless connection information) different from the setting wireless connection information (the first wireless connection information). The unique wireless connection information is wireless connection information unique to each scanner 4, and is, for example, an SSID and a password at a time when the scanner 4 functions as an access point.

When a predetermined trigger is detected, the connection information replacement unit 510 replaces the unique wireless connection information used by the wireless connection unit 500 with the setting wireless connection information. For example, the connection information replacement unit 510 replaces the unique wireless connection information used by the wireless connection unit 500 with the setting wireless connection information, when a predetermined activation operation is performed. When the predetermined activation operation is performed and activation is performed in a setting mode, the connection information replacement unit 510 of the present example replaces the unique SSID and password used by the wireless connection unit 500 with the SSID and password common to each device type.

The setting information reception unit 520 receives the setting information from the computer terminal 2 via a wireless connection using the setting wireless connection information. The setting information reception unit 520 of the present example directly connects to the computer terminal 2 by using the setting wireless connection information, and receives, via this wireless connection, setting information (an SSID and a password) for connecting to the WiFi router 6.

The connection setting unit 530 performs a setting for connecting to the WiFi router 6, based on the setting information received by the setting information reception unit 520.

The connection information change-back unit 540 changes the setting wireless connection information back to the unique wireless connection information, when the setting information relating to the wireless connection is received by the setting information reception unit 520. After the setting information reception unit 520 receives the setting information relating to the wireless connection and notifies the computer terminal 2 of the reception, the connection information change-back unit 540 of the present example changes the wireless connection information used by the wireless connection unit 500 (the common SSID and password) back to the SSID and password unique to the scanner 4.

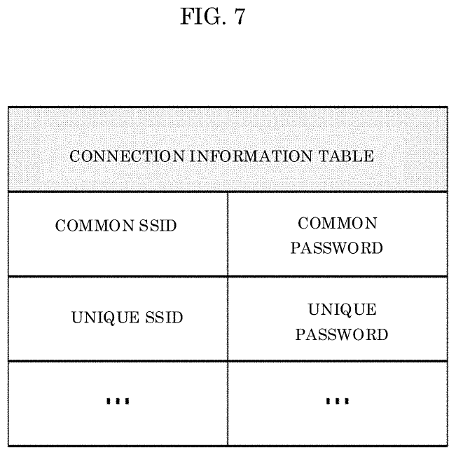

As illustrated in FIG. 7, the connection information DB 570 stores a common SSID used in the setting mode and a unique SSID and password used in a normal mode. The common SSID and password are, for example, an SSID and a password common to each scanner device type. For example, the unique SSID contains a serial number of the scanner 4, and the unique password contains a random character string, and thus, the unique SSID and password are different for each scanner.

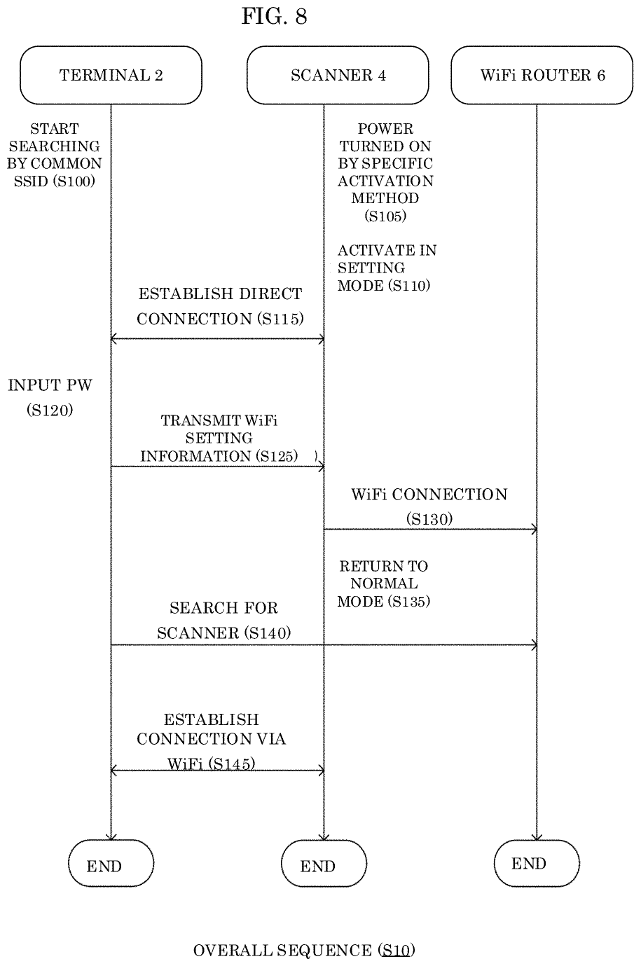

FIG. 8 is a sequence chart for describing an overall operation (S10) of the information processing system 1.

As illustrated in FIG. 8, in step 100 (S100), when the computer terminal 2 activates the driver program 3 and starts WiFi setting for the scanner 4, the computer terminal 2 searches for the access point, based on the common SSID registered in advance.

In step 105 (S105), when the user depresses a power button by a specific activation method, the scanner 4 starts to activate.

In step 110 (S110), the scanner 4 is activated in the setting mode and serves as a wireless access point using a common SSID and password.

In step 115 (S115), the computer terminal 2 uses the common SSID to discover the scanner 4 as an access point, and uses the common password to directly connect to the scanner 4.

In step 120 (S120), the computer terminal 2 displays a password input screen (FIGS. 2A and 2B) and receives a password input by a user. The input password is a password for accessing the WiFi router 6.

In step 125 (S125), the computer terminal 2 transmits the password input by the user and the SSID of the WiFi router 6 as WiFi setting information to the scanner 4.

In step 130 (S130), the scanner 4 uses the WiFi setting information received from the computer terminal 2 to perform setting for connecting to the WiFi router 6 and to establish a wireless connection with the WiFi router 6.

In step 135 (S135), the scanner 4 changes from the setting mode back to the normal mode, and changes the wireless connection information used when the scanner 4 functions as a wireless access point, back to the unique SSID and password.

In step 140 (S140), the computer terminal 2 connects to the WiFi router 6 and searches for the scanner 4 via the WiFi router 6.

If the computer terminal 2 discovers the scanner 4 in step 145 (S145), the computer terminal 2 connects to the scanner 4 via the WiFi router 6 and starts utilizing the scanner 4.

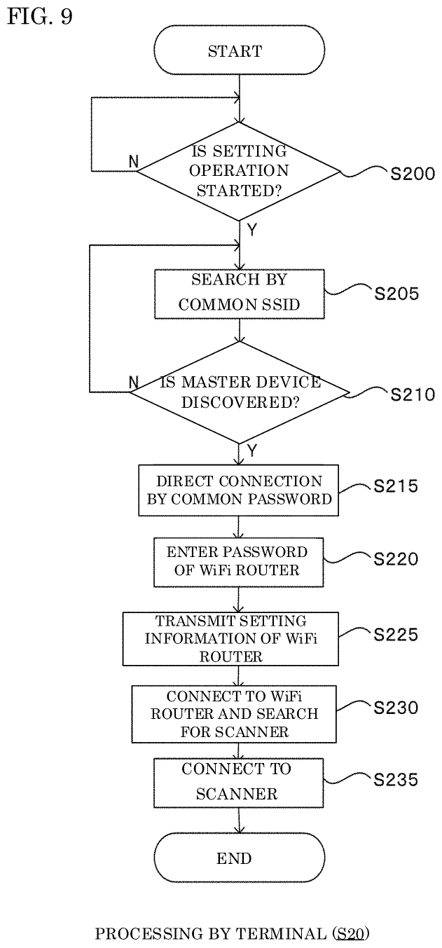

FIG. 9 is a flowchart for describing a processing (S20) by the computer terminal in the information processing system 1 in more detail.

As illustrated in FIG. 9, in step 200 (S200), when the computer terminal 2 activates the driver program 3 (FIG. 5) in response to a user operation, the driver program 3 goes into standby until a WiFi setting operation of the scanner 4 is started (S200: No), and if the WiFi setting operation is started (S200: Yes), the processing proceeds to a process of S205.

In step 205 (S205), the connection request unit 300 reads the common SSID and password stored in the connection information DB 370 in advance, and uses the read common SSID to search for the access point (the scanner 4). Furthermore, the setting assistance unit 320 causes the computer terminal 2 to display an image indicating a specific activation method, and prompts the user to perform a specific operation to the scanner 4.

In step 210 (S210), the connection request unit 300 continues searching for the access point (the scanner 4) (S210: No) until discovering the access point, and if the connection request unit 300 discovers the access point (the scanner 4) (S210: Yes), the processing proceeds to a process of S215.

In step 215 (S215), the connection request unit 300 transmits the password read from the connection information DB 370 to the discovered scanner 4 (access point), and automatically connects to the scanner 4 via a direct connection.

In step 220 (S220), the setting assistance unit 320 displays the password input screen to receive a password input by the user.

In step 225 (S225), the setting information transmission unit 310 transmits the password received by the setting assistance unit 320 and the SSID of the WiFi router 6 stored in advance, as WiFi setting information, to the scanner 4 directly connected to the connection request unit 300.

In step 230 (S230), when confirming that the WiFi setting information is successfully transmitted by the setting information transmission unit 310, the connection request unit 300 disconnects the direct connection with the scanner 4, connects to the WiFi router 6, and searches for the scanner 4 in a local area network (LAN) of the WiFi router 6.

In step 235 (S235), if the connection request unit 300 discovers the scanner 4 in the LAN of the WiFi router 6, the connection request unit 300 connects to the scanner 4 via the WiFi router 6 and the scanner control unit 330 starts controlling the scanner 4.

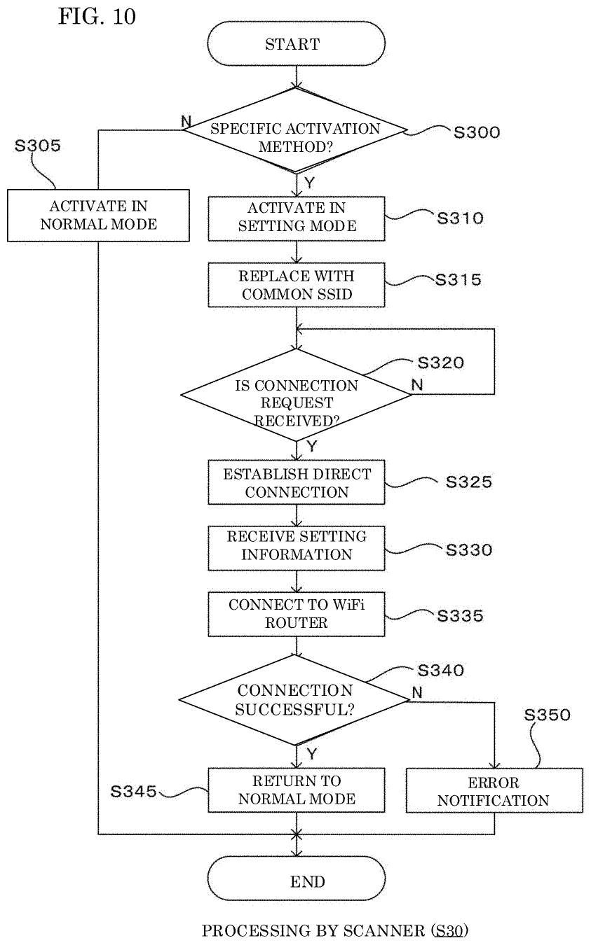

FIG. 10 is a flowchart for describing a processing (S30) by the scanner in the information processing system 1 in more detail.

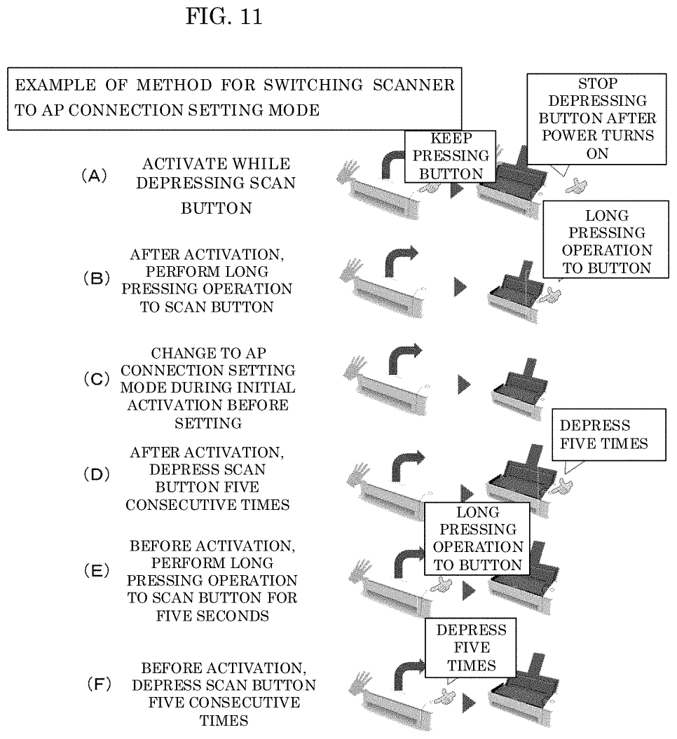

As illustrated in FIG. 10, in step 300 (S300), the scanner 4 (the scanner program 5) determines whether or not the scanner 4 is activated by the specific activation method, and if the scanner 4 is activated by the specific activation method, the processing proceeds to a process of S310, and if the scanner 4 is not activated by the specific activation method, the processing proceeds to a process of S305. As illustrated in FIG. 11A, the specific activation method is, for example, a method of opening the cover while depressing the scan button to activate the scanner 4.

In step 305 (S305), the scanner program 5 (FIG. 6) is activated in the normal mode and functions as an access point using a unique SSID and password.

In step 310 (S310), the scanner program 5 is activated in the setting mode.

In step 315 (S315), the connection information replacement unit 510 replaces the wireless connection information of the wireless connection unit 500 with a common SSID and password.

In step 320 (S320), the wireless connection unit 500 goes into standby (S320: No) until reception of a request for wireless connection as a wireless access point using the common SSID and password after replacement by the connection information replacement unit 510, and if a request for wireless connection is received, the processing proceeds to a process of S325.

In step 325 (S325), in response to the wireless connection request, the wireless connection unit 500 authenticates the wireless connection request by using the common password, and establishes a direct connection with a terminal (the computer terminal 2) requesting connection. When the direct connection is established, the wireless connection unit 500 rejects an access request from another terminal and communicates only with the terminal with which the direct connection is established.

In step 330 (S330), the setting information reception unit 520 uses the direct connection established by the wireless connection unit 500 to receive WiFi setting information. Upon receiving the WiFi setting information, the setting information reception unit 520 transmits, to the computer terminal 2, a reply indicating that the WiFi setting information is normally received.

In step 335 (S335), the connection setting unit 530 uses the WiFi setting information received by the setting information reception unit 520 to perform setting for connecting to the WiFi router 6 and to establish a wireless connection with the WiFi router 6.

In step 340 (S340), the scanner program 5 determines whether or not the wireless connection with the WiFi router 6 is successfully established. If the wireless connection is successfully established, the processing proceeds to a process of S345, and if establishment of the wireless connection fails, the processing proceeds to a process of S350.

In step 345 (S345), the connection information change-back unit 540 changes the wireless connection information back to the unique SSID and password, to achieve returning to the normal mode.

In step 350 (S350), the scanner program 5 transmits a notification about an error.

As described above, according to the information processing system 1 of the present embodiment, when the scanner 4 is activated by the specific activation method, the scanner 4 is activated in the setting mode and functions as a wireless access point using an SSID and password common to each device type. This makes it possible to automatically connect the computer terminal 2 and the scanner 4 by a direct connection and perform WiFi setting of the scanner 4 by using this direct connection. That is, it is possible to set the wireless connection between the scanner 4 and the WiFi router 6 simply by activating the scanner 4 and entering the password of the WiFi router 6. As a result, it is possible to significantly reduce the effort required until the scanner 4 can be used, to reduce the burden on the user, and to significantly shorten the time until the scanner 4 can be used.

Furthermore, a period during which the common SSID and password are valid is limited to a short period, and thus, it is possible to minimize security risks while realizing a simple direct connection.

Next, a modification of the above-described embodiment will be described.

FIG. 11 is a diagram illustrating variations of the specific activation method for the scanner 4.

In the embodiment described above, the activation method of FIG. 11A is described as the “specific activation method”, but the activation method is not limited thereto. For example, as illustrated in FIG. 11B, the specific activation method may be “an operation of performing a long pressing operation to the scan button after activating the scanner”. Furthermore, as illustrated in FIG. 11C, the “specific activation method” may be an initial activation operation of the scanner. Moreover, as illustrated in FIG. 11D, the specific activation method may be “an operation of depressing the scan button five consecutive times after activating the scanner”. Furthermore, as illustrated in FIG. 11E, the specific activation method may be “an operation of performing a long pressing operation for five seconds to the scan button before activating the scanner”, and the specific activation method may be “an operation of depressing the scan button five consecutive times before activating the scanner”, as illustrated in FIG. 11F.

In the embodiment described above, an embodiment in which a common SSID and password are used is described, but it is also possible to use only the common SSID, without using the password. Furthermore, a set of an SSID that is common only in part and a common password may be used.

The above-described embodiment is described by assuming that only the one scanner 4 is discovered, but it is possible to use a configuration in which, if a plurality of the scanners 4 are discovered, selection from the plurality of the scanners 4 is available on the computer terminal 2. Methods of selecting a scanner include the following two patterns. In a first pattern, when the plurality of scanners 4 are found, the common SSID and password are used to establish a connection with the plurality of scanners 4 in the order in which the scanners 4 are found. Afterwards, scanner names are acquired from information about the scanners 4 and the scanner names are displayed on a screen. Next, a message such as “Set up this scanner?” is displayed to ask the user to select a scanner.

In a second pattern, the SSID is composed of “a common portion+a unique portion” (for example, ABCD-EFGH). Specifically, the common portion (ABCD) is used as the common SSID and the unique portion (EFGH) is a character string different from scanner to scanner. It is determined whether the common (initial) portion of the SSID is ABCD, and if only one SSID is found, a connection is established, and if a plurality of SSIDs are found, the user receives a notification so that the user can identify the scanner from a portion of the unique portion (EFGH) and select the scanner.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### REFERENCE SIGNS LIST

1 Information processing system
2 Computer terminal
3 Driver program
4 Scanner
5 Scanner program
6 WiFi router

What is claimed is:

1. An information processing system comprising:
a computer terminal; and
a peripheral device, wherein
the computer terminal comprising a processor configured to:
store first wireless connection information for connecting by wireless to a predetermined access point, and
request a wireless connection by using the stored first wireless connection information, and
the peripheral device comprising a processor configured to:
establish a wireless connection by using second wireless connection information different from the first wireless connection information, and
replace the second wireless connection information with the first wireless connection information.

2. The information processing system according to claim 1, wherein the processor is configured to:
store the first wireless connection information in association with software for controlling the peripheral device.

3. The information processing system according to claim 2, wherein the computer terminal comprising the processor is further configured to:
transmit to the peripheral device, setting information relating to a wireless connection, by using a wireless connection using the first wireless connection information, and
the peripheral device comprising the processor is further configured to:
change the first wireless connection information back to the second wireless connection information, when the setting information relating to the wireless connection is transmitted.

4. The information processing system according to claim 3, wherein the processor is configured to:
store, as the first wireless connection information, a common SSID and password that are common to a plurality of peripheral devices,
replace a unique SSID and password that are unique to each of the plurality of peripheral devices with the common SSID and password, and
change the common SSID and password back to the unique SSID and password.

5. The information processing system according to claim 4, wherein the processor is configured to:
perform replacement to the first wireless connection information used for receiving setting information for a wireless connection, when a predetermined activation operation is performed.

6. A peripheral device, comprising a processor configured to:
receive a wireless connection by using predetermined wireless connection information;
change wireless connection information to setting wireless connection information different from the predetermined wireless connection information; and
change the wireless connection information back to the predetermined wireless connection information, when receiving setting information by using the setting wireless connection information.

7. A setting method, comprising the steps of:
replacing predetermined wireless connection information with setting wireless connection information different from the predetermined wireless connection information; and
changing the setting wireless connection information set as a result of the replacing, back to the predetermined wireless connection information, when receiving setting information by using the setting wireless connection information.
